(19) United States
(12) Patent Application Publication
(10) Pub. No.: US 2017/0305322 A1
(43) Pub. Date: Oct. 26, 2017

(54) Dump Truck Box with Reduced Tendency for Material to Stick at the Sides of the Box

(71) Applicants: Germanic Mfg. Ltd., Rathwell (CA); Heart-Fab Ltd., Hazelridge (CA)

(72) Inventor: Gilbert Hofer, Rathwell (CA)

(21) Appl. No.: 15/135,991

(22) Filed: Apr. 22, 2016

(51) Int. Cl. B60P 1/16; B60P 1/28

(52) U.S. Cl. CPC B60P 1/16; B60P 1/28

(57) ABSTRACT

In a dump truck of the type having a frame mounted on ground wheels, a dump box having a floor, two side walls, a front wall at a front end and an open rear end with a tail gate where the dump box is supported on the frame for movement between a lowered position for storing and transporting materials and a raised position where the front end is elevated for dumping the materials out of the open rear of the dump box under gravity, the side walls are tapered so that a spacing at the front end is less than a spacing at the rear end so that the materials as they slide forwardly come away from the side walls to reduce pressure on the side walls and aid the sliding.

This invention relates to a dump truck box with reduced tendency for material to stick at the sides of the box.

### BACKGROUND OF THE INVENTION

A typical dump truck includes a dump box that is movable usually by pivoting between a lowered position for storing and transporting items and a raised position for dumping the items out of the dump box at the rear. A typical dump box includes a floor, a pair of side walls, a front wall, and an open rear end for accomplishing this function where the open rear end of the dump box includes a pair of upstanding corner posts. A tailgate is supported on the side walls of the dump box adjacent to the open rear end for pivoting movement between a closed position in which the tailgate closes the open rear end of the dump box for facilitating the storing and transporting of the items therein and an opened position in which the tailgate is pivoted away from the open rear end of the dump box for facilitating the dumping of the items out of the dump box.

In many instances, the tailgate is affirmatively moved between the opened and closed positions by means of a cylinder (typically a pneumatic cylinder) that extends between the dump box and the tailgate. When the cylinder is extended, the tailgate is pivoted away from the open rear end of the dump box to the opened position. When the cylinder is retracted, the tailgate is pivoted toward the open rear end of the dump box to the closed position. In this manner, the operation of the cylinder controls the movement of the tailgate between the opened and closed positions.

Such dump trucks can be mounted on a rigid one piece frame of a transport vehicle or as a semi-trailer to be attached to a highway tractor or in some cases as a trailer. In all cases the box it lifted at a front end to tilt the box sufficiently to discharge the material in a sliding action over the floor and sides to and through the tailgate.

Such dump trucks can be used for transporting different materials, such as soil, gravel, sand and other flowable particulate materials. In some cases the flowability is such that the material can discharge though the rear opening at the tail gate without difficult and without the tendency to stick. However other materials often have sufficient adhesion to the sides and floor so as to cause sticking of the material in discharge so that a part or all of the material my become hung up in the box. This is particularly so at the front of the box as there is less weight of material above the material attaching to the walls to cause it to fall. Often therefor some material may flow freely from the box and other material particularly at the front remains stuck. In this case the driver is often reduced to trying to shake the material free by driving and braking. This technique is in many cases not successful and in other cases can lead to the vehicle toppling due to the accumulation of material at the very top of the now tilted box with very dangerous and damaging consequences.

Up to now there has been little progress in solving this problem. Solutions such as coatings or coverings over the sides and floor can be tried but involve extra cost.

### SUMMARY OF THE INVENTION

It is an object of the present invention to provide a dump truck of this general type which has a reduced tendency for the material to stick to the sides of the dump box.

According to the invention there is provided a dump truck comprising:

a frame mounted on ground wheels;

a dump box having a floor, two side walls, a front wall at a front end and an open rear end with a tail gate;

the dump box being supported on the frame for movement between a lowered position for storing and transporting materials and a raised position where the front end is elevated for dumping the materials out of the open rear of the dump box under gravity;

the tailgate being supported on the dump box for movement between a closed position, wherein the tailgate closes the open rear end of the dump box, and an opened position, wherein the tailgate is spaced away from the open end of the dump box for allowing discharge of the material;

the box being tapered so that a spacing between the side walls at the front end is less than a spacing at the rear end.

In this way the materials as they slide forwardly come away from the side walls, as the spacing gradually increases as a constant taper, to reduce pressure on the side walls and aid the sliding. That is, even at a low rate of taper where for example the side walls are spaced at the rear by a distance in the range 5 inches to 30 inches and more preferably of the order of 6 to 10 inches greater than the spacing at the front, once the material has moved toward the rear by a few feet, the width of the stored material is less than the spacing between the side walls thus reducing the pressure between the edge of the material and the side wall.

In most cases a main part of each of the side walls is vertical.

In some cases the side wall meets the floor at a right angle, but more preferably each of the side walls includes a bottom portion inclined to the floor and to the main part of the side wall as this tends to reduce sticking of the material in a right angle corner.

In this way preferably a width of the floor is tapered so that the floor at the rear end is wider than the floor at the front end.

Preferably the side walls and the floor are formed simply from steel panels or other metal without any additional coating so as to define a metal inside surface.

Preferably the box, as in conventional dump trucks of this type, has a length of at least 20 feet and more typically as much as 40 feet, but the concept can be used in any dump truck having a box of this general type. As is also conventional, the box typically has a substantially constant height along a top edge of the side walls.

### BRIEF DESCRIPTION OF THE DRAWINGS

One embodiment of the invention will now be described in conjunction with the accompanying drawings in which:

FIG. 1 is a perspective view of a dump truck including a first embodiment of a double cylinder assembly in accordance with this invention.

FIG. 2 is an isometric view of the box only of the truck of FIG. 1

FIG. 3 is an end elevational view of the box only of the truck of FIG. 1 showing the difference in dimensions of the rear end relative to the front end of the box.

In the drawings like characters of reference indicate corresponding parts in the different figures.

### DETAILED DESCRIPTION

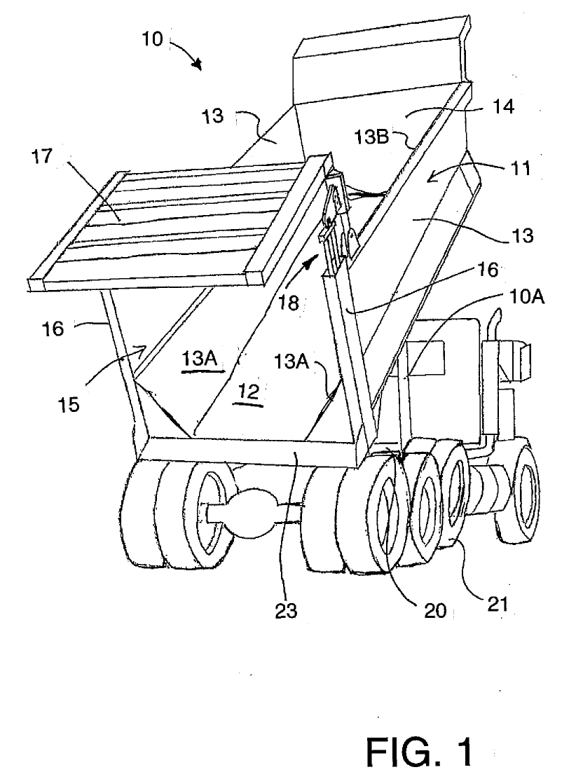

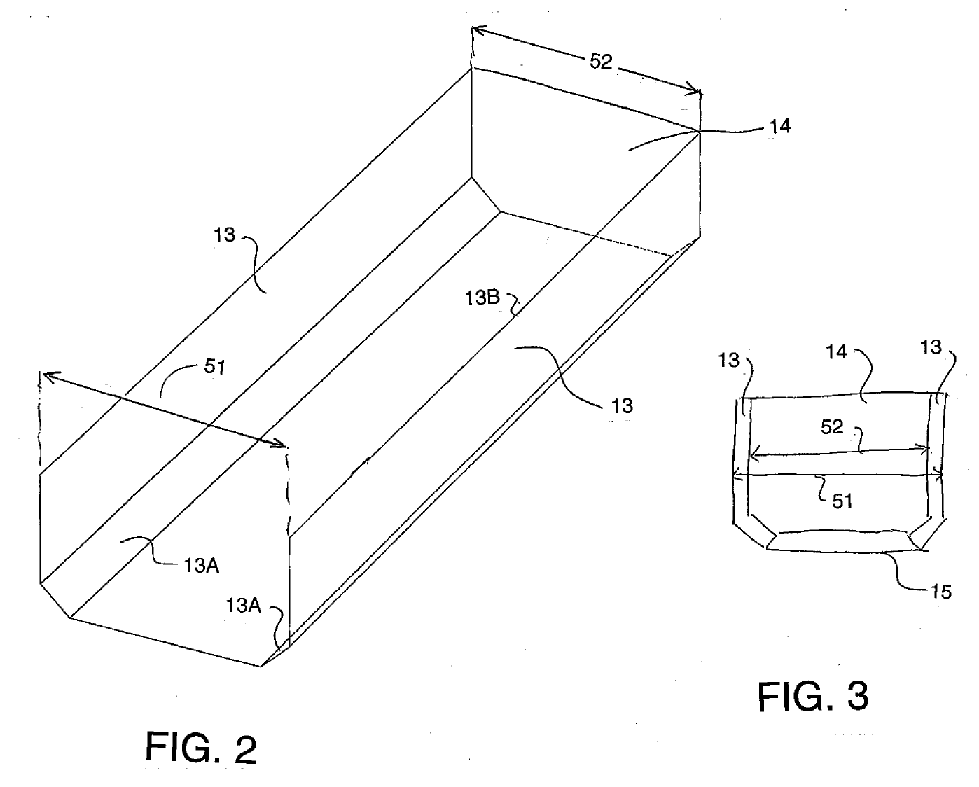

Referring now to the drawings, there is illustrated in FIG. 1 a dump truck, indicated generally at 10, including a frame that supports a dump box 11 that is pivotable by a hydraulic lift system 10A between a lowered position for storing and transporting items and a raised position as shown for dumping the items out of the dump box 11 through an open rear. The dump box 11 includes a floor 12, a pair of vertical side walls 13, a front wall 14, and an open rear end 15. The open rear end 15 of the dump box 11 has a pair of upstanding corner posts 16 that are each formed from a hollow rectangular member. A tailgate 17 is supported on the side walls 13 of the dump box 11 adjacent to the open rear end 15 for pivoting movement between a closed position wherein the tailgate 17 closes the open rear end 15 of the dump box 11 and an opened position wherein the tailgate 17 is spaced away from the open rear end 15 of the dump box 11, as shown in FIG. 1. The tailgate 17 is moved between the opened and closed positions by means of one or more single cylinders 18.

The dump truck further includes a frame 20 mounted on ground wheels 21 for transportation as a trailer or semi-trailer or on a rigid frame as shown by example.

The dump box is supported on the frame for movement between a lowered position for storing and transporting materials and the raised position shown where the front end is elevated for dumping the materials out of the open rear of the dump box under gravity over a rear discharge beam 23

The box being tapered so that a spacing S2 between the side walls at the front end is less than a spacing S1 at the rear end.

Each of the side walls 13 includes a bottom portion 13A inclined to the floor and to the main part of the side wall. The box has a substantially constant height along a top edge 13B of the side walls 13

A width of the floor 12 is tapered so that the floor at the rear end is wider than the floor at the front end.

1. A dump truck comprising:
a frame mounted on ground wheels;
a dump box having a floor, two side walls, a front wall at a front end and an open rear end with a tail gate;
the dump box being supported on the frame for movement between a lowered position for storing and transporting materials and a raised position where the front end is elevated for dumping the materials out of the open rear of the dump box under gravity;
the tailgate being supported on the dump box for movement between a closed position, wherein the tailgate closes the open rear end of the dump box, and an opened position, wherein the tailgate is spaced away from the open end of the dump box for allowing discharge of the material;
the side walls being tapered so that a spacing at the front end is less than a spacing at the rear end.

2. The dump truck according to claim 1 wherein a main part of each of the side walls is vertical.

3. The dump truck according to claim 2 wherein each of the side walls includes a bottom portion inclined to the floor and to the main part of the side wall.

4. The dump truck according to claim 1 wherein a width of the floor is tapered so that the floor at the rear end is wider than the floor at the front end.

5. The dump truck according to claim 1 wherein the side walls and the floor are metal so as to define a metal inside surface.

6. The dump truck according to claim 1 wherein the side walls are wider at the front by a distance in the range 5 inches to 30 inches and more preferably of the order of 6 to 10 inches.

7. The dump truck according to claim 1 wherein the box has a length of at least 20 feet.

8. The dump truck according to claim 1 wherein the box has a substantially constant height along a top edge of the side walls.
